(19) United States
(12) Patent Application Publication
(10) Pub. No.: US 2014/0347170 A1
(43) Pub. Date: Nov. 27, 2014

(54) Method and Terminal for Managing Radio Frequency Identification Card

(71) Applicants: Zuhong Gui, Shenzhen (CN); Gang Liu, Shenzhen (CN); Zhenyu Zhang, Shenzhen (CN)

(72) Inventors: Zuhong Gui, Shenzhen (CN); Gang Liu, Shenzhen (CN); Zhenyu Zhang, Shenzhen (CN)

(73) Assignee: ZTE CORPORATION, Shenzhen, Guangdong (CN)

(21) Appl. No.: 14/344,567

(22) PCT Filed: Oct. 20, 2011
(86) PCT No.: PCT/CN2011/081071

§ 371 Date: Mar. 12, 2014

(30) Foreign Application Priority Data
Sep. 16, 2011 (CN) 201110276031.6

(51) Int. Cl. G06K 7/10

(52) U.S. Cl. CPC G06K 7/10198
USPC 340/10.51

(57) ABSTRACT

The present disclosure provides a method and a terminal for managing a Radio Frequency Identification (RFID) card, which can activate a NFC read-write mode of the terminal, the terminal reads RFID information of a RFID card to be managed and updates the RFID information into a RFID information database. The present disclosure establishes the RFID information database on the terminal by using NFC technology, when the terminal is used to replace the corresponding RFID card for service, RFID information stored in the information database of the terminal will be written into a security chip module of the terminal, and a NFC control module of the terminal is enabled to be in a NFC simulation mode so as to enable the terminal to implement the corresponding functions of the RFID card. The above technical solutions can solve the problem that it is inconvenient for a user to manage multiple RFID cards he holds, and avoid loss that may be caused during use of a RFID card, thus implementing convenient and secure management of the RFID card.

### TECHNICAL FIELD

The present disclosure relates to the field of communications, and in particular to a method and a terminal for managing a Radio Frequency Identification (RFID) card based on RFID technology and Near Field Communication (NFC) technology.

### BACKGROUND

RFID is also referred to as an electronic tag, which has following characteristics: capable of identifying a specific objective by a radio signal and reading/writing related data without establishing a mechanical or optical contact between an identification device and the specific objective. At present, various applications of RFID technology has been applied in people's daily life and work, various RFID cards closely related to people's daily life can be seen everywhere, such as a library management card, an access control card, an electronic ticket, an automatic road toll card, a bus pass, a bank card and the like.

NFC has following characteristics: capable of implementing bidirectional identification and connection within an operating distance of about 10 cm. With the development of NFC technology, people's habits of consumption also change a lot accordingly, such as implementing a contactless payment by using a mobile terminal based on NFC technology to have the advantages of being secure, convenient, fast and stylish.

Generally, a NFC terminal has three function modes as follows:
as an identification and read device, i.e., a reader-writer, by which a standard RFID card can be read and written;
as an device being read, i.e., a terminal card simulation mode, in which the terminal can simulate a RFID card; and
a Peer-to-Peer (P2P) mode, in which a point-to-point communications can be implemented between NFC terminals.

Referring to a basic schematic diagram of a NFC terminal as shown in FIG. 1, the NFC terminal includes an antenna, a NFC chip, a cellular baseband chip and a security chip. Under the control of the cellular baseband chip, the NFC chip can switch among the three function modes by the built-in antenna of the terminal. In FIG. 1, the security chip is configured to store sensitive data of a user and related NFC applications, communicate with an external read-write device via the NFC chip, and realize the secure storage and transmission of data.

With the wide application of RFID technology in daily life, a user may hold more and more RFID cards, and those RFID cards become a necessity in his/her life, for example, the RFID cards held by the user may include a bus pass, a bank card, a room key, a car key and the like. However, it may also cause inconvenience for the user to take along and manage so many RFID cards, and loss or damage of any RFID card may bring trouble to the user's life.

### SUMMARY

The present disclosure is intended to provide a method and a terminal for managing a RFID card, so as to solve the problem in the prior art that it is difficult for a user to manage or take along multiple RFID cards, thus implementing management of multiple RFID cards.

To this end, the technical solutions of the present disclosure are implemented as follows.

A method for managing a Radio Frequency Identification (RFID) card, including:
activating a Near Field Communication (NFC) read-write mode of a terminal; and
reading, by the terminal, RFID information of a RFID card to be managed and updating the RFID information into a RFID information database.

Before the step of reading, by the terminal, RFID information of a RFID card to be managed, the method further includes:
sending, by the terminal, a request for reading RFID information to the RFID card; and
responding, by the RFID card, to the request and sending the RFID information to the terminal.

After all the steps are implemented, the method further includes following steps:
retrieving, by the terminal, RFID information corresponding to a RFID service device from the RFID information database;
activating a NFC simulation mode of the terminal; and sending, by the terminal, the corresponding RFID information to the RFID service device.

After the step of retrieving, by the terminal, RFID information corresponding to a RFID service device from the RFID information database, the method further includes temporarily storing the RFID information into a security chip module.

After all the steps are implemented, the method further includes:
deleting the RFID information temporarily stored in the security chip module.

A terminal for managing a RFID card, including a controller, a NFC control module, and a data storage module, wherein
the controller, connected to the data storage module and the NFC control module respectively, is configured to activate the NFC module to be in a read-write mode or a simulation mode; and further configured to send RFID information of a RFID card to be managed read by the NFC control module to the data storage module;
the NFC control module is configured to read the RFID information of the RFID card to be managed and to send the RFID information to the controller; and
the data storage module is configured to store the RFID information of the RFID card to be managed to form a RFID information database.

The terminal further includes a security chip module connected to the NFC control module, and the security chip module is configured to temporarily store RFID information corresponding to a RFID service device retrieved from the data storage module by the controller.

When the NFC control module establishes a connection with the RFID service device, the controller is configured to retrieve the RFID information corresponding to the RFID service device from the data storage module and to send the RFID information by the NFC control module to the security chip module.

The terminal further includes a man-machine conversation module connected to the controller, and the man-machine conversation module is configured to implement man-machine interaction.

The NFC control module includes an antenna module configured to implement information interaction with the RFID card and a RFID service device.

It can be seen from above technical solutions of the present disclosure that a RFID information database is established on a terminal by using NFC technology, when the terminal is used to replace the corresponding RFID card for service, RFID information stored in the information database of the terminal will be written into a security chip module of the terminal, and a NFC control module of the terminal is enabled to be in a NFC simulation mode so as to enable the terminal to implement the corresponding functions of the RFID card. The above technical solutions can solve the problem that it is inconvenient for a user to manage multiple RFID cards he holds, and avoid loss that may be caused during use of a RFID card, thus implementing convenient and secure management of the RFID card.

### BRIEF DESCRIPTION OF THE DRAWINGS

FIG. 1 shows a basic schematic diagram of a NFC terminal;

FIG. 2 shows a structure diagram of a terminal for managing a RFID card according to an embodiment of the present disclosure;

FIG. 3 shows a schematic diagram of reading RFID information of a RFID card by a terminal according to an embodiment of the present disclosure;

FIG. 4 shows a schematic diagram of replacing a RFID card for service by a terminal according to an embodiment of the present disclosure;

FIG. 5 shows a flowchart for managing a RFID card according to an embodiment of the present disclosure;

FIG. 6 shows a flowchart for establishing a RFID information database according to embodiments of the present disclosure; and

FIG. 7 shows a flowchart for using a terminal to replace a RFID card for service according to embodiments of the present disclosure.

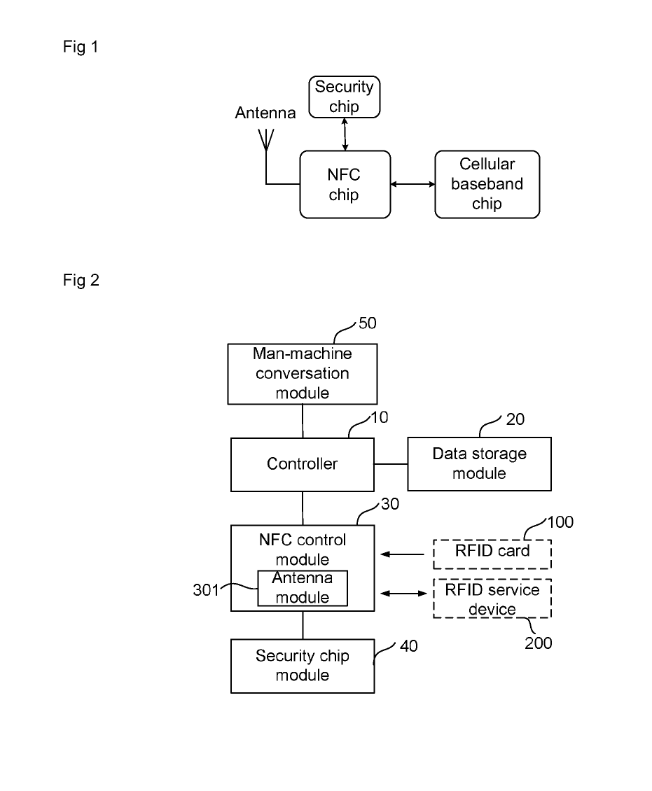

### DETAILED DESCRIPTION

In order to make the technical problem to be solved, technical solutions and advantages of the present disclosure clearer, the present disclosure will be further explained in detail below with reference to the drawings and embodiments. It should be appreciated that the specific embodiments are only used to explain the present disclosure instead of limiting the present disclosure.

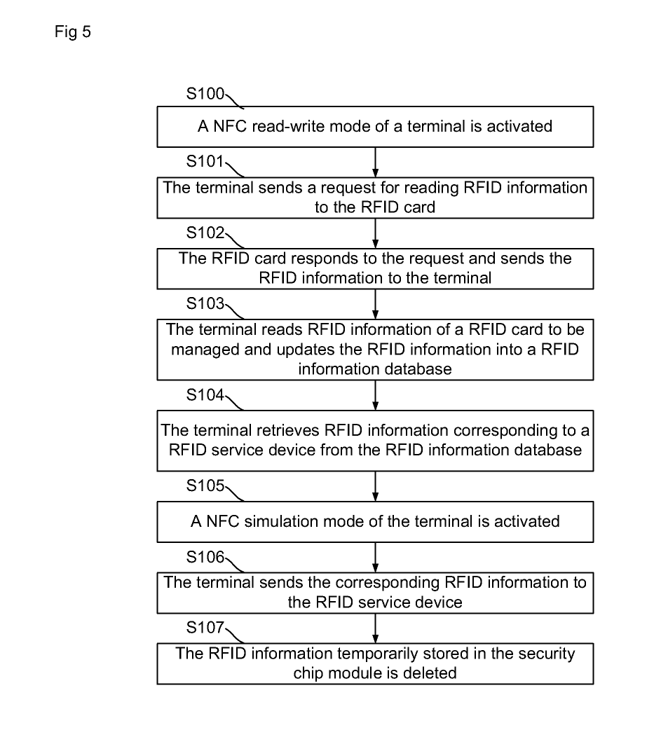

Referring to FIG. 5, it shows a flowchart for managing a RFID card according to an embodiment of the present disclosure. The flow includes the following steps:
S100: A Near Field Communication (NFC) read-write mode of a terminal is activated; and
S103: The terminal reads RFID information of a RFID card to be managed and updates the RFID information into a RFID information database.

Specifically, the terminal refers to a NFC terminal, in which the currently matured NFC technology is integrated, the terminal may be a portable terminal such as a mobile phone, a Personal Digital Assistant (PDA), a smart phone and the like.

The RFID card to be managed may be various cards, such as a bus pass, a bank card, a room key, a car key and the like, the terminal collects the RFID information of these RFID cards to eventually form a RFID information database, so as to use the terminal to replace the corresponding RFID card when required subsequently to implement the corresponding service, for example, when using the terminal to replace a bus pass for payment service, a card reader (i.e., the RFID service device described below) reads the corresponding RFID information from the terminal and implement the payment service.

When the quantity of RFID cards held by a user increases continuously, the RFID information database stored in a terminal may be updated according to the method described above, so as to enable the terminal a function for managing several kinds of RFID cards.

In a preferred embodiment, before the step S103, i.e., before the step of reading, by the terminal, RFID information of a RFID card to be managed, the flow further includes:
S101: The terminal sends a request for reading RFID information to the RFID card; and
S102: The RFID card responds to the request and sends the RFID information to the terminal.

In a preferred embodiment, after implementing all the steps, the flow further includes the following steps:
S104: The terminal retrieves RFID information corresponding to a RFID service device from the RFID information database;
S105: A NFC simulation mode of the terminal is activated; and
S106: The terminal sends the corresponding RFID information to the RFID service device.

In steps S104 to S106, a terminal pre-stored with the RFID information database is used to replace the RFID card for implementing the corresponding function. After the terminal retrieves the RFID information corresponding to the RFID service device from the RFID information database, it can store temporarily the RFID information in the security chip module. When the RFID service device (such as a card reader) requests the terminal for the RFID information, the terminal will respond to the request and send the RFID information temporarily stored in the security chip module to the RFID service device.

In a preferred embodiment, after implementing the above steps S100 to S106, the flow further includes:
S107: The RFID information temporarily stored in the security chip module is deleted.

The flow for establishing a RFID information database and the flow for replacing a RFID card by a terminal for service will be described respectively below.

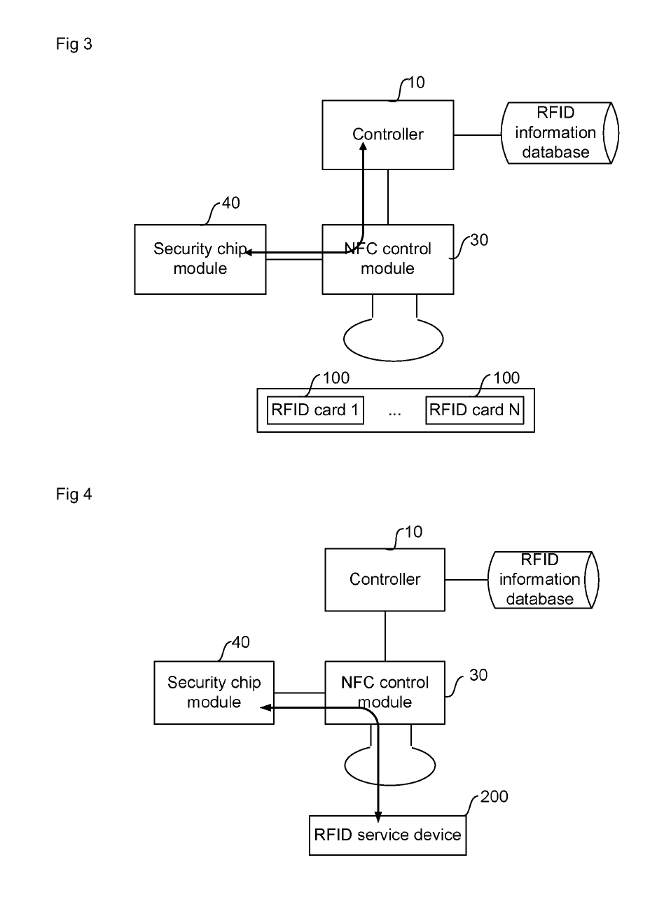

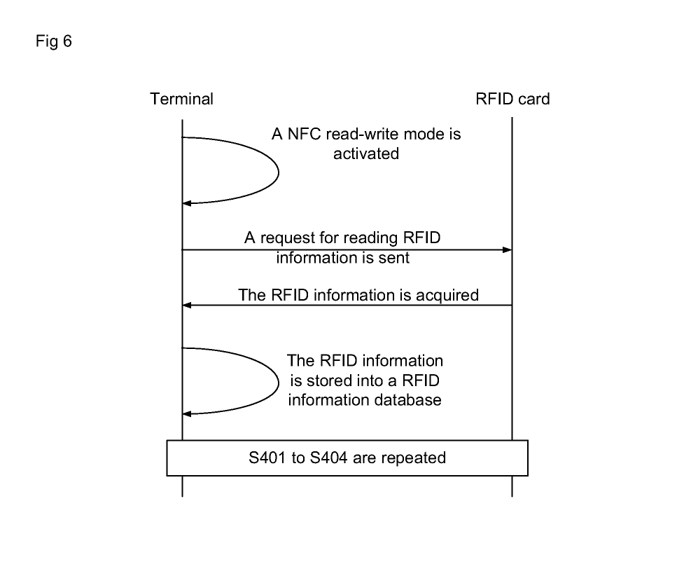

Referring to FIG. 6, it shows a flowchart for establishing a RFID information database according to an embodiment of the present disclosure. In conjunction with FIG. 3, the flow shown in FIG. 6 includes the following steps:
S401: A NFC read-write mode of a terminal is activated;
S402: The terminal sends a request for reading RFID information to a RFID card;
S403: The RFID card responds to the request, and the terminal acquires the RFID information stored in the RFID card;
S404: The terminal stores the acquired RFID information of the RFID card in a local RFID information database; and
S405: For the other RFID cards, S401 to S404 may be implemented repeatedly to implement the RFID information acquisition of multiple RFID cards, so as to establish RFID information databases of a user's RFID cards.

It should be noted that in FIG. 3, a controller 10 configures the terminal to be in the NFC read-write mode by a NFC control module 30. The terminal reads the information in various RFID cards and establishes the RFID information database by using the acquired information.

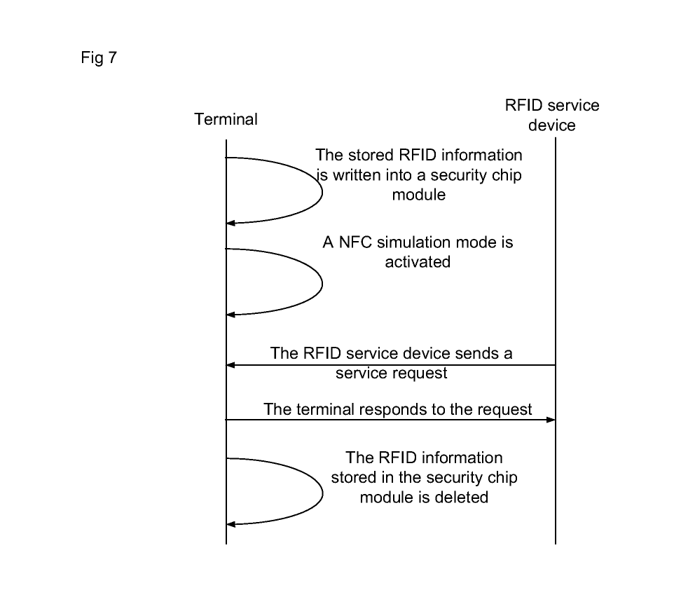

Referring to FIG. 7, it shows a flowchart for using a terminal to replace a RFID card for service according to embodiments of the present disclosure, in conjunction with FIG. 4, the flow shown in FIG. 7 includes the following steps:
S501: A RFID service device establishes a connection with the terminal according to the present disclosure (for example, by approaching the terminal to the RFID service device, based on the NFC technology held by the terminal itself, the terminal establishes a connection with the RFID service device). After the connection relation is established, the terminal searches the RFID information corresponding to the RFID service device from the RFID information database in itself, and writes the RFID information into the security chip module by the NFC control module;
S502: A NFC simulation mode of the terminal is activated;
S503: The RFID service device sends a service request to the terminal;
S504: The terminal responds to the service request of the RFID service device, acquires the corresponding RFID information from a security chip module, and sends the RFID information to the RFID service device;
S505: After the terminal transmits the RFID information to the RFID service device, the current RFID information in the security chip module is deleted.

It should be noted that in FIG. 4, when a user needs to use a RFID card service, the card information in the RFID information database may be stored into a security chip module 40 by a controller 10. At this point, the terminal is configured to be in a card simulation mode, and a RFID service device 200 can acquire all the required information from the security chip module 40. The other card service are processed in the similar way, in this way, the objective of replacing multiple cards with the terminal is achieved.

Referring to FIG. 2, it shows a structure diagram of a terminal for managing a RFID card according to embodiments of the present disclosure. A controller 10, a NFC control module 30 and a data storage module 20 are included in FIG. 2, wherein the controller 10, connected to the data storage module 20 and the NFC control module 30 respectively, is configured to activate the NFC module 30 to be in a NFC read-write mode or a NFC simulation mode; and further configured to send RFID information of a RFID card to be managed read by the NFC control module 30 to the data storage module 20;
for example, when the terminal is a mobile phone, the controller 10 may be a cellular baseband chip, which is configured to control and activate a NFC control module 30 in the mobile phone to be in the NFC read-write mode, thus the cellular baseband chip reads the RFID information from the RFID card by the NFC control module 30, or writes the corresponding RFID information acquired from a RFID information database of the data storage module 20 into a security chip module; in addition, the controller 10 is further configured to control and activate the NFC control module 30 in the mobile phone to be in the NFC simulation mode, when an external RFID service device establishes a connection with the mobile phone, the controller 10 retrieves the RFID information corresponding to the RFID service device from the data storage module 20 and sends the RFID information to the security chip module by the NFC control module 30, so that the NFC control module 30 acquires the corresponding RFID information from the security chip module to implement information interaction with the RFID service device, thus implementing the corresponding service of the RFID service device.
the NFC control module 30 is configured to read the RFID information of the RFID card to be managed and to send the RFID information to the controller 10; and
the data storage module 20 is configured to store the RFID information of the RFID card to be managed to form the RFID information database.

In a preferred embodiment, the terminal for managing a RFID card further includes a security chip module 40 connected to the NFC control module 30, and the security chip module 40 is configured to temporarily store RFID information corresponding to a RFID service device retrieved from the data storage module 20 by the controller 10. When the controller 10 of the terminal controls and activates the NFC control module 30 in the mobile phone to be in the NFC simulation mode, when an external RFID service device establishes a connection with the mobile phone, the controller 10 retrieves the RFID information corresponding to the RFID service device from the data storage module 20 and sends the RFID information to the security chip module 40 by the NFC control module 30, so that the NFC control module 30 acquires the corresponding RFID information from the security chip module 40 to implement information interaction with the RFID service device, thus implementing the corresponding service of the RFID service device. When the information interaction between the NFC control module 30 and the RFID service device completes, the controller 10 controls the NFC control module 30 to delete the RFID information stored in the security chip module 40.

In a preferred embodiment, the NFC control module 30 includes an antenna module 301 configured to implement information interaction with the RFID card and a RFID service device.

In a more preferred embodiment, the terminal for managing a RFID card further includes a man-machine conversation module 50 connected to the controller 10, and the man-machine conversation module 50 is configured to implement man-machine interaction,. For example, the man-machine conversation module may prompt a user which operation mode the NFC control module 30 is in under the control of the terminal.

It can be seen from above technical solutions of the present disclosure that a RFID information database is established on a terminal by using NFC technology, when the terminal is used to replace the corresponding RFID card for service, RFID information stored in the information database of the terminal will be written into a security chip module 40 of the terminal, and a NFC control module 30 of the terminal is enabled to be in a NFC simulation mode so as to enable the terminal to implement the corresponding functions of the RFID card. The above technical solutions can solve the problem that it is inconvenient for a user to manage multiple RFID cards he holds, and avoid loss that may be caused during use of a RFID card, thus implementing convenient and secure management of the RFID card.

The above are merely the preferred embodiments of the present disclosure, and are not intended to limit the scope of protection of the claims of the present disclosure.

1. A method for managing a Radio Frequency Identification (RFID) card, comprising:
activating a Near Field Communication (NFC) read-write mode of a terminal; and
reading, by the terminal, RFID information of a RFID card to be managed and updating the RFID information into a RFID information database.

2. The method according to claim 1, wherein before the step of reading, by the terminal, RFID information of a RFID card to be managed, the method further comprises:
sending, by the terminal, a request for reading RFID information to the RFID card; and
responding, by the RFID card, to the request and sending the RFID information to the terminal.

3. The method according to claim , wherein after all the steps are implemented, the method further comprises following steps:
retrieving, by the terminal, RFID information corresponding to a RFID service device from the RFID information database;
activating a NFC simulation mode of the terminal; and
sending, by the terminal, the corresponding RFID information to the RFID service device.

4. The method according to claim 3, wherein after step of retrieving, by the terminal, RFID information corresponding to a RFID service device from the RFID information database, the method further comprises:
temporarily storing the RFID information into a security chip module.

5. The method according to claim 4, wherein after all the steps are implemented, the method further comprises:
deleting the RFID information temporarily stored in the security chip module.

6. A terminal for managing a RFID card, comprising a controller, a NFC control module, and a data storage module, wherein
the controller, connected to the data storage module and the NFC control module respectively, is configured to activate the NFC module to be in a NFC read-write mode or a NFC simulation mode, and further configured to send RFID information of a RFID card to be managed read by the NFC control module to the data storage module;
the NFC control module is configured to read the RFID information of the RFID card to be managed and to send the RFID information to the controller; and
the data storage module is configured to store the RFID information of the RFID card to be managed to form a RFID information database.

7. The terminal according to claim 6, wherein the terminal further comprises a security chip module connected to the NFC control module, and the security chip module is configured to temporarily store RFID information corresponding to a RFID service device retrieved from the data storage module by the controller.

8. The terminal according to claim 7, wherein when the NFC control module establishes a connection with the RFID service device, the controller is configured to retrieve the RFID information corresponding to the RFID service device from the data storage module and to send the RFID information by the NFC control module to the security chip module.

9. The terminal according to claim 6, wherein the terminal further comprises a man-machine conversation module connected to the controller, and the man-machine conversation module is configured to implement man-machine interaction.

10. The terminal according to claim 6, wherein the NFC control module comprises an antenna module configured to implement information interaction with the RFID card and a RFID service device.

11. The method according to claim 2, wherein after all the steps are implemented, the method further comprises following steps:
retrieving, by the terminal, RFID information corresponding to a RFID service device from the RFID information database;
activating a NFC simulation mode of the terminal; and
sending, by the terminal, the corresponding RFID information to the RFID service device.

12. The method according to claim 11, wherein after step of retrieving, by the terminal, RFID information corresponding to a RFID service device from the RFID information database, the method further comprises:
temporarily storing the RFID information into a security chip module.

13. The method according to claim 12, wherein after all the steps are implemented, the method further comprises:
deleting the RFID information temporarily stored in the security chip module.

14. The terminal according to claim 7, wherein the terminal further comprises a man-machine conversation module connected to the controller, and the man-machine conversation module is configured to implement man-machine interaction.

15. The terminal according to claim 8, wherein the terminal further comprises a man-machine conversation module connected to the controller, and the man-machine conversation module is configured to implement man-machine interaction.
